(19) United States
(12) Patent Application Publication
(10) Pub. No.: US 2002/0045152 A1
(43) Pub. Date: Apr. 18, 2002

(54) Process for controlled image capture and distribution

(76) Inventors: James S. Viscardi, Pittsford, NY (US); Michael R. Rooksby, Rochester, NY (US); Howard C. Rooksby, Rochester, NY (US)

Correspondence Address: Ronald S. Kareken, Esq., Jaeckle Fleischmann & Mugel, LLP, 39 State Street, Rochester, NY, 14614-1310, US

(21) Appl. No.: 09/939,318

(22) Filed: Aug. 24, 2001

Related U.S. Application Data
(60) Provisional application No. 60/228,582, filed on Aug. 29, 2000.

(51) Int. Cl. G09B 19/00; G09B 5/00

(52) U.S. Cl. 434/219; 434/307 R

(57) ABSTRACT

Process for the collection and controlled distribution of images from inspection equipment, by the capture, editing and controlled dissemination of the images and their associated descriptive information for later use in the training of operators of the inspection equipment.

### FIELD OF INVENTION

This invention relates to the collection and controlled distribution of images from inspection equipment, and more specifically to the capture, editing and controlled dissemination of such images and their associated descriptive information for later uses, as, for example in the training of operators of the inspection equipment. Priority is claimed in co-pending U.S. Provisional Patent Application No. 60/228,582, filed Aug. 29, 2000.

### BACKGROUND OF THE INVENTION

Inspection machines, and more particularly specialized X-ray machines, are used widely at airports, post offices, parcel delivery services, secure government buildings and the like to inspect luggage and parcels to determine whether they contain objects or materials which are unsafe, illegal to transport or carry, or otherwise prohibited. During the course of normal operation, many operators of the X-ray machines may encounter relatively unique or different objects that can cause delays in the inspection process unless the operators had been trained beforehand to recognize those objects.

As will be expected, training requirements for the equipment operators will differ from one inspection site to another. In addition, most of the current X-ray inspection machines with which we are familiar use closed system machine architecture having proprietary image capture and viewing algorithms. Recently, however, at least some inspection machine manufacturers have converted to a model that enables conversion of proprietary image data to a standard digital file format that most desktop computers can display. Each manufacturer may have its own method for producing the standard image file, and some are reluctant to release that information to their customers.

### SUMMARY

In view of the vast numbers of inspection equipment operators required at any one time 5 throughout the world, and the very high turnover rate of those operators at many critical locations, there have been developed various Computer Based Training (CBT) courses to provide standardized training to current and prospective equipment operators. As part of the CBT course content, certain standard images of inspected objects will be displayed for both familiarization and testing. For that purpose, we have determined that it would be very useful provide CBT courses with the ability to incorporate images customized to meet the unique inspection requirements of a specific site, which we believe will satisfy a clear training need at a reasonable cost.

Our invention enables the use of image input from actual operation of an inspection system at specific sites by providing for the accumulation and conversion of unique object images to a common digital file format, collecting data specific to each image, and assembling the image and associated data in a database to be incorporated in the relevant CBT course for use in training the operators of the inspection system, effectively honing the abilities of the operators and ensuring that the inspection process will maintain and improve accuracy in the midst of continual change of the objects confronted during actual inspection. The invention accomplishes these objectives across a wide range of diverse inspection systems and image formats, while enabling, if required, various degrees of control with respect to access and security of each location's images and information.

### DESCRIPTION OF DRAWINGS

The invention will be better understood from the following description of a preferred embodiment and the accompanying drawings, in which

FIG. 1 shows the general processing flow of the invention;

FIG. 2 shows an expansion of detail of the general processing flow shown in FIG. 1, and appends the installation process and final data;

FIG. 3 shows how the appearance and capture of unknown images are used to improve the training of the users of the inspection system; and

FIG. 4 shows a high-level view of the entire system, with a single supplier processing the image information of many clients.

### DETAILED DESCRIPTION OF THE INVENTION

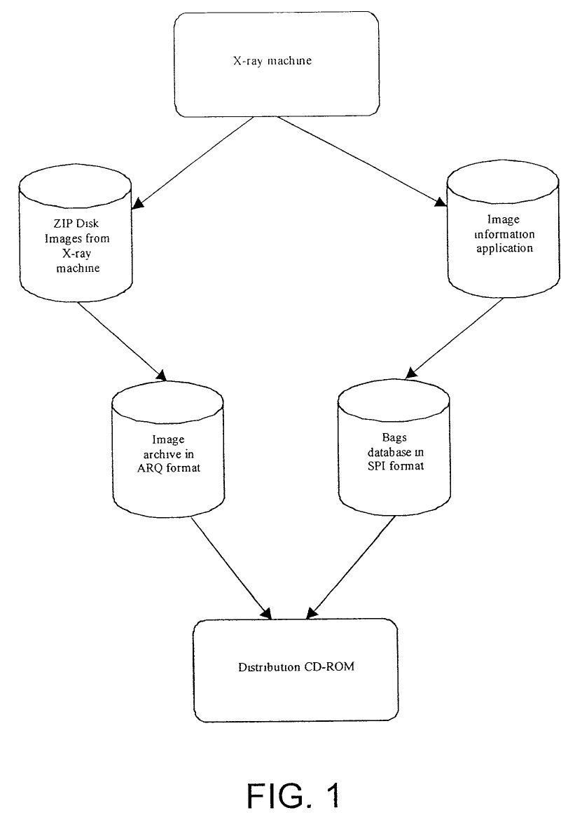

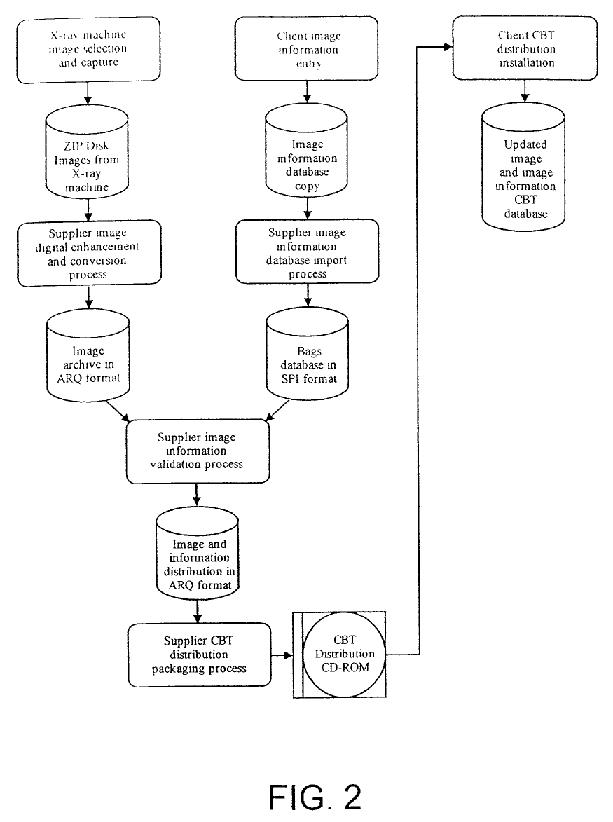

FIG. 1 illustrates a general flow of the invention based on the identification and capture of data from the X-ray machines used in the inspection process to the final distribution of CBT course content or content updates on appropriate media, e.g., a CD-ROM containing the updated image information and/or downloaded from an Internet site. FIG. 2 breaks this flow down into more-detailed steps. By reference to a “user” in the drawings is meant an individual such as an X-ray machine operator who compares images encountered in an inspection process with a set of known images observed because of prior CBT training, in order to identify or categorize the encountered images. The term “client” is intended to refer to an organization for whom the user is employed and who collects, identifies and uses image information, and trains users in the matching of encountered images with those in the client's collection of available known images and image information. By “supplier” is meant an organization which gathers, organizes, edits and distributes image information for incorporation into CBT courses and/or course updates.

Referring specifically to FIG. 1, the invention comprises one or more (three shown) clients each with CBT capability and with computer systems including a processor, a main memory, a storage system capable of storing large numbers of image and image information files, a software program to convert any of several image formats into a single common file format, a software program to gather multiple elements of information relating to each image and store them in an image information file, and a software program to store image files and image information files on transportable media. The illustrated supplier will include a computer system having a processor, a main memory, a storage system capable of storing large numbers of image and image information files, a software program to retrieve image files and image information files from transportable media, a software program to edit and enhance images stored in image files, a software program to import image information files into an image information database, a software program to validate and cross-match each image to its associated image information file and the specific client(s), and a software program to archive all validated image files and image information files in a computer-based-training compatible format, store them on compact, large-volume transportable media, and transmit the media to the relevant client(s).

### OPERATION OF THE INVENTION

The invention's process comprises three stages of operation: collection, production and distribution. The stages and some of their details are shown in FIG. 2.

In the collection process, images are collected, along with information associated with each image, and stored in the client computer system for a given client. For user training purposes using the CBT output of the invention, the following information is obtained and stored for each image:

Object (e.g., bag) description

Innocent contents description

Threat description

Category (select one of seven)

Initial user decision

Final user decision (if necessary)

Difficulty Level of observation

Machine type with image option

Comments

A software application with a graphical user interface allows clients to enter and store the needed information about each unique image identified from a prior inspection that is determined to be useful for incorporation into the CBT. The client uses this application to complete the image collection process. The application references each image, provides appropriate image names for the client, encrypts all image data, and stores the encrypted data for later retrieval by the supplier. When the client is ready to send the image information to the supplier, the application creates an archive file and compresses it on the client's hard drive. The application will also make multiple copies of the database to send to the supplier. Using this back-up method, the supplier can retrieve any files lost during shipping or due to file corruption.

In the production process, the supplier receives the database and image files from the client, loads them onto the supplier computer system, and begins pre-production work by digitally enhancing each image to ensure all items in the image are clear and visible. The image is then converted to a standard format, e.g., the JPEG format, and sized appropriately to fit inside of the supplier's CBT courseware.

The supplier then processes the information about the images. The supplier opens a database containing all of the information about the images and imports the information to a database file for use with the CBT. The supplier validates the information and then uses it to cross check all of the images. If there is an image missing the entire set is removed from or isolated within the database for later correction. The supplier links missing images and/or associated data back to the respective client, who can assist in locating them.

Finally, the supplier packages all of the images and information into an encrypted archive file, in a format such as ARQ, ready for distribution to the applicable client(s). The archive file contains all of the databases and index files needed to use these images in the supplier provided CBT courseware by direct incorporation as an update to the courseware and/or as a stand-alone training refresher program.

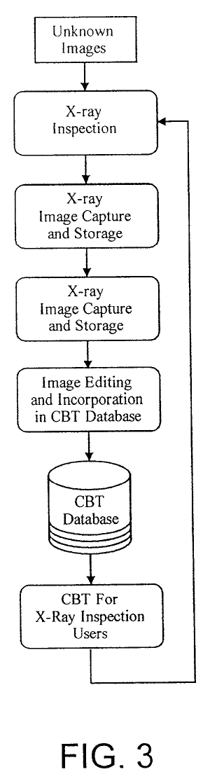

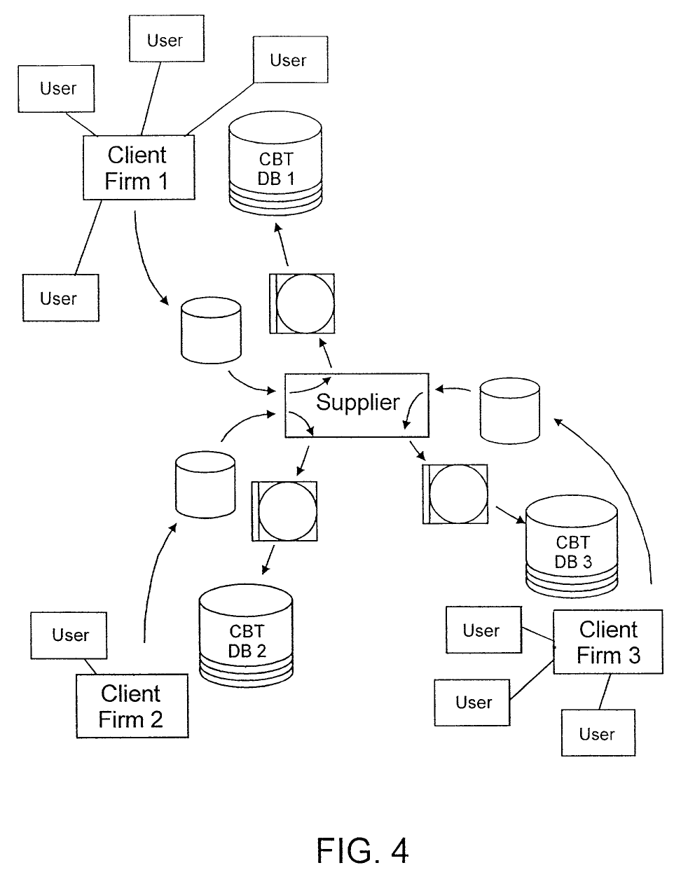

In the distribution process, after pre-processing and packaging of all of the images, the supplier places the files on permanent storage media such as CD-ROM for distribution and/or on a computer server to be accessed directly by the client(s) using security pass codes. Depending on the service contracts between the client and the supplier, each client may receive a CD-ROM, customized with the unique image data needed for that client's use, to install on the client's inspection system, or a pass code to access the supplier's server. The CD-ROM or server program contains an installer program that automatically updates the client image library and databases. The installer program verifies that the client has a valid copy of the invention's software, moves old files to the trash and installs the new image files. The installer also re-indexes the files and prepares the system for normal operation. When the next user logs in to use the CBT, the new images are made available. FIG. 3 shows the feedback of unknown images into the training process so as to make them recognizable and classifiable to the users or inspectors. FIG. 4 shows how this feedback process is performed by a single supplier for multiple clients.

The effect of the use of the invention is the continuing improvement of the inspection process, both from the standpoint of the availability of accurate, up-to-date image information and from the standpoint of successful user application of that information. The invention accomplishes this continual-improvement process in a simple, responsive, and efficient manner, while maintaining appropriate separation among the client organizations and their data.

We claim:

1. A process for training of operators of image producing inspection equipment by a computer based training (CBT) program produced by a CBT supplier, the method comprising (1) capturing, editing and characterizing selected images produced by and/or for the equipment, (2) producing relevant descriptive data for each image, (3) converting if required the images to a common computer file format, (4) producing a computer file of the descriptive data and associating the data file to its specific image, (5) assembling the image files and associated data in a combined database, and (6) incorporating the database in the CBT program.

2. The process according to claim 1 in which images are produced for a plurality of different CBT programs used with different inspection equipment, and further comprising the step of identifying and incorporating in each of the CBT programs only the portions of the database applicable to the equipment for which the specific images were captured.

3. The process according to claim 1 in which the descriptive information collected comprises equipment type, object category (e.g., bag), object description, innocence and/or threat level description, and user decision on handling the object (e.g., pass, reject, inspect).

4. The process according to claim 1 in which steps 1 and 2 are performed by equipment operators and the balance of the steps by the CBT supplier.

5. The process according to claim 1 in which step 3 further comprises the step of enhancing each image to ensure all items in the image are clear and visible.

6. The process according to claim 1 and further comprising the step of encrypting the computer file and/or database.

7. The process according to claim 1 in which the database is either stored on fixed media or is made accessible from a computer server to be accessed directly by the equipment operator with a security pass code.

8. The process according to claim 7 in which the CBT program is configured to automatically install the computer file on activation of the CBT program by the equipment operator.
